(19) United States
(12) Patent Application Publication
(10) Pub. No.: US 2025/0012910 A1
(43) Pub. Date: Jan. 9, 2025

(54) LIVE / FORWARD-FACING SONAR TRANSDUCER MOUNT AND AIMING SYSTEM FOR ATTACHMENT TO ELECTRIC TROLLING MOTOR

(71) Applicant: R. Paul Bird, JR., Henderson, KY (US)

(72) Inventor: R. Paul Bird, JR., Henderson, KY (US)

(21) Appl. No.: 18/757,068

(22) Filed: Jun. 27, 2024

Related U.S. Application Data
(63) Continuation-in-part of application No. 18/218,281, filed on Jul. 5, 2023.

(51) Int. Cl. G01S 7/521; B63H 20/00; B63H 20/12; B63H 25/52; G01S 15/96

(52) U.S. Cl. CPC G01S 7/521; B63H 20/007; B63H 20/12; B63H 25/52; G01S 15/96

(57) ABSTRACT

A sonar transducer mount and aiming system for attachment to an electric trolling motor, which includes a rotary actuator assembly and a rotating shaft. The rotary actuator assembly includes a housing that is secured to the electric trolling motor and a rotating coupler is rotationally driven. The rotating shaft is connected to and rotates with the rotating coupler and includes a sonar transducer mounting point. The rotating shaft of the sonar transducer mount and aiming system and the electric trolling motor shaft have a common axis of rotation and are configured to rotate independently from one another about the common axis of rotation.

### CROSS-REFERENCE TO RELATED APPLICATIONS

This application is a continuation-in-part of U.S. patent application Ser. No. 18/218,281, which was filed on Jul. 5, 2023. The entire disclosure of the above application is incorporated herein by reference.

### FIELD

The subject disclosure is generally directed to sonar transducer mounts and aiming systems and more particularly to live/forward-facing sonar transducer mounts and aiming systems that are designed for attachment to an electric trolling motor.

### BACKGROUND

This section provides background information related to the present disclosure which is not necessarily prior art.

Live/forward-facing sonar has become a game changing technology for the sport of fishing. Traditional sonar, including traditional down-scan and side-scan sonars, display a running log or time track of the water column beneath or to the sides of a boat. Any fish return is a snap-shot in time that shows where the fish was when the boat passed over the fish or by the fish. As a result, traditional sonar works best when the boat is moving through the water at or close to idle speeds. Live sonar is different. Live sonar provides a real-time view of the water column and as a result, anglers can see fish swimming around and reacting to a lure, which can also be visible depending on water conditions and lure size/type. Live sonar works well when the boat is stationary and at slow speeds. As a result, live sonar has become particularly useful and popular among bass and crappie anglers. Examples of live sonar include Garmin LiveScope and Garmin's earlier Panoptix sonars, Lowrance ActiveTarget, and Humminbird MEGA Live.

Live sonar is also different from traditional sonar in that anglers must aim the live sonar transducer, which typically has a narrower cone than traditional sonar, for best results. In this regard, using live sonar is much like using a flashlight in the dark. You can only see what the flashlight is pointing at so if you are looking for something (e.g., fish, baitfish, or structure in the case of live sonar), you must move the beam around (i.e., panning).

There are three general categories of sonar mounts that allow anglers to aim a live sonar transducer: (1) trolling motor mount, (2) a manual pole mount, and (3) an electric pole mount. The first category of trolling motor mounts utilizes a mounting bracket where the sonar transducer is mounted directly to the shaft or barrel (i.e., lower unit) of an electric trolling motor (typically a bow-mount electric trolling motor). Using this type of mount, the sonar transducer always moves/rotates with the shaft/lower unit of the electric trolling motor. Thus, an angler can aim a live sonar transducer by steering the electric trolling motor. A problem with this type of sonar transducer mount is that the transducer cannot be rotated/aimed independently of the heading of the electric trolling motor and vice versa. As a result, if an angler wants to use the electric trolling motor to move the boat along a particular heading or position the boat in current, the angler cannot pan around with the live sonar transducer or independently point the sonar transducer in a different direction. This mounting solution is even more problematic when the live sonar transducer is mounted to the shaft or barrel of an electric trolling motor that has an automated guidance (auto pilot) and/or anchoring system that autonomously guides the boat or holds the boat over a particular location because such systems frequently make small steering adjustments. Because the shaft/barrel of the electric trolling motor frequently moves when these systems are activated, the clarity of the live sonar image is compromised. These problems led to the development of the second two categories of transducer mounts and aiming systems.

When a manual pole mount or electric mount solution is used, the live sonar transducer is typically mounted on the end of a remote shaft or pole that is either mounted to a non-moving part of the electric trolling motor or separately mounted to the boat. The remote shaft or pole can be rotated manually, such as by a simple handle, or by controlling an electric motor. As a result, anglers can steer the boat with the electric trolling motor independently of aiming the live sonar transducer.

In such systems, the remote shaft or pole is laterally spaced from the electric trolling motor shaft and often runs parallel to the electric trolling motor shaft. Typically, this remote shaft sits well above the top cap of a boat when the electric trolling motor is stowed, which can interfere with or obscure the forward view of the driver and/or passengers, is less aerodynamic, and is exposed and is therefore more prone to damage, particularly when docking. Because the remote shaft of such sonar transducer mounts is spaced from the electric trolling motor shaft and is typically only supported near the top of the shaft, it can be prone to bending or breaking in the event of impact or even under its own weight and the weight of the sonar transducer when a boat is running in rough water. The susceptibility of these designs to damage continues when the electric trolling motor is deployed because the remote shaft is left exposed in the water and is typically one of the most forward parts of the boat when attached to a bow-mount trolling motor. The spacing of the remote shaft of the sonar transducer mount and the electric trolling motor shaft also means that there is another shaft in the water that can collect weeds and that must be cleaned of debris when the electric trolling motor is stowed. Accordingly, there are unsolved problems with all three categories of existing transducer mounts and aiming systems.

### SUMMARY

This section provides a general summary of the disclosure and is not a comprehensive disclosure of its full scope or all of its features.

In accordance with one aspect of the present disclosure, a sonar transducer mount and aiming system for attachment to an electric trolling motor is provided. The transducer mount and aiming system includes a rotary actuator assembly and a rotating shaft. The rotary actuator assembly includes a housing and a rotating coupler. The housing of the rotary actuator assembly is configured to be fixedly secured in place to the electric trolling motor. The rotating coupler is rotationally driven relative to the housing. The rotating shaft extends between a first shaft end and a second shaft end. The first shaft end is connected to and rotates with the rotating coupler of the rotary actuator assembly. The second shaft end includes a sonar transducer mounting point, which is configured to receive a sonar transducer. As discussed herein, the sonar transducer may be a live scan sonar transducer but could alternatively be a different type of sonar transducer that benefits from being rotated or aimed.

The rotating shaft of the sonar transducer mount and aiming system and the electric trolling motor shaft have a common axis of rotation and are configured to rotate independently from one another about the common axis of rotation. This allows the heading of the sonar transducer mounting point to be maintained independently of any rotation of the electric trolling motor shaft by steering inputs (whether manually or by an auto pilot or anchoring system). This also allows the heading of the sonar transducer mounting point to be adjusted by rotating the rotating shaft without affecting the heading of the electric trolling motor. In other words, the sonar transducer mount and aiming system allows the sonar transducer and the electric trolling motor to operate independently and point in different directions, which is particularly useful when fishing along a shoreline or fishing in current, while at the same time providing a compact and streamline arrangement where both the electric trolling motor shaft and the rotating shaft of the sonar transducer mount and aiming system share a common axis of rotation.

In accordance with another aspect of the present disclosure, a system is provided that includes both the electric trolling motor and the sonar transducer mount and aiming system. The electric trolling motor includes an electric trolling motor shaft and a lower unit that is connected to the electric trolling motor shaft. Again, the sonar transducer mount and aiming system includes a rotary actuator assembly and a rotating shaft. The rotary actuator assembly has a housing and a rotating coupler. The housing of the rotary actuator assembly is fixedly secured to the electric trolling motor. The rotating coupler is rotationally driven relative to the housing. The rotating shaft extends between a first shaft end and a second shaft end. The first shaft end is connected to and rotates with the rotating coupler of the rotary actuator assembly. The second shaft end includes a sonar transducer mounting point. The rotating shaft of the sonar transducer mount and aiming system and at least a portion of the electric trolling motor shaft independently rotate about a common axis that forms a centerline of the electric trolling motor shaft.

This arrangement, where the rotating shaft of the sonar transducer mount and aiming system and the electric trolling motor shaft share a common axis of rotation affords a number of benefits. Unlike other sonar transducer mounts and aiming systems that utilize a shaft that has an axis of rotation that is parallel to and spaced from the axis of rotation of the electric trolling motor shaft, the arrangement described herein is far more compact and streamlined and therefore does not interfere with or obscure the forward view of the driver and/or passengers, is more aerodynamic, is less exposed and therefore is less prone to damage, does not require secondary braces or supports extending to the deck/casting platform/gunnel of the boat for rough water running when the electric trolling motor is stowed, is less prone to collecting weeds when the electric trolling motor is deployed, and has a better overall appearance.

In accordance with another aspect of the present disclosure, a sonar transducer mount and aiming system for attachment to an electric trolling motor is provided that includes a rotary actuator, a rotating shaft, and a control pedal. Again, the rotary actuator assembly includes a housing and a rotating coupler. The housing of the rotary actuator assembly is configured to be fixedly secured to the electric trolling motor. The rotating coupler is rotationally driven relative to the housing by an electric motor that is coupled to the rotating coupler through a gear set. The rotating shaft extends between a first shaft end and a second shaft end. The first shaft end is connected to and rotates with the rotating coupler of the rotary actuator assembly. The second shaft end includes a sonar transducer mounting point. The rotating shaft of the sonar transducer mount and aiming system is configured to rotate independently of the electric trolling motor shaft.

The control pedal is electrically connected to the electric motor of the rotary actuator assembly. The control pedal is configured to adjust a rotational position of the rotating shaft and therefore a heading associated with the sonar transducer mounting point. In addition, an array of indicator lights may be mounted along a lighted perimeter of the boat (such as around at least a portion of a casting deck or gunnel) to provide an illuminated heading that corresponds with the heading associated with the sonar transducer mounting point. Because the array of indicator lights extend around the casting deck or gunnel of the boat, an angler can directly visualize the direction in which the sonar transducer mounting point and therefore the sonar transducer is pointed, which makes it easier for the angler to cast a bait in that same direction so that it falls within the sonar beam emitted by the transducer. This feature is particularly useful because live sonar systems currently on the market typically have transducers that emit a relatively narrow sonar beam, so it can be difficult for anglers to consistently cast a bait within the sonar beam so that the bait is displayed on the sonar screen (along with nearby structure and fish reacting to the bait). This system provides a solution to that problem.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a front elevation view of an exemplary sonar transducer mount and aiming system that is illustrated installed on an exemplary electric trolling motor;

FIG. 2 is a front perspective view of the exemplary sonar transducer mount and aiming system shown in FIG. 1;

FIG. 3 is an exploded top perspective view of an upper portion of the exemplary sonar transducer mount and aiming system shown in FIG. 2;

FIG. 4 is a front perspective view of another exemplary sonar transducer mount and aiming system that includes a one-piece outer shaft;

FIG. 5 is an exploded top perspective view of an upper portion of the exemplary sonar transducer mount and aiming system shown in FIG. 4;

FIG. 6 is an exploded bottom perspective view of the upper portion of the exemplary sonar transducer mount and aiming system shown in FIG. 4;

FIG. 7 is a front perspective view of another exemplary sonar transducer mount and aiming system that includes a two-piece rotating shaft and is illustrated with an exemplary sonar transducer installed on a lower portion of the exemplary sonar transducer mount and aiming system;

FIG. 8 is an exploded top perspective view of an upper portion of the exemplary sonar transducer mount and aiming system shown in FIG. 7;

FIG. 9 is an exploded bottom perspective view of the upper portion of the exemplary sonar transducer mount and aiming system shown in FIG. 7;

FIG. 10 is an enlarged front perspective view of the lower portion of the exemplary sonar transducer mount and aiming system shown in FIG. 7;

FIG. 11 is an exploded top perspective view of the lower portion of the exemplary sonar transducer mount and aiming system shown in FIG. 7;

FIG. 12 is a side elevation view of the lower portion of the exemplary sonar transducer mount and aiming system shown in FIG. 7 where the exemplary sonar transducer is shown in a first position configured for forward or down imaging;

FIG. 13 is another side elevation view of the lower portion of the exemplary sonar transducer mount and aiming system shown in FIG. 7 where the exemplary sonar transducer is shown in a second position configured for perspective or landscape imaging;

FIG. 14 is a top perspective view of an exemplary control pedal for the exemplary sonar transducer mount and aiming systems shown in FIGS. 1-13 where a ring of indicator lights are illustrated that display the direction the sonar transducer is aiming;

FIG. 15 is another top perspective view of the exemplary control pedal shown in FIG. 14 where the ring of indicator lights are illustrated that display the direction the sonar transducer is aiming and the panning limits of an automated sonar sweep range;

FIG. 16 is a front perspective view of a forward casting deck of a boat equipped with an electric trolling motor and an exemplary sonar traducer mount and aiming system where an array of indicator lights has been placed on the gunnel of the boat to provide a lighted perimeter around a portion of the forward casting deck;

FIG. 17 is a front elevation view of another exemplary sonar transducer mount and aiming system that is illustrated installed on an exemplary electric trolling motor;

FIG. 18 is a front perspective view of the exemplary sonar transducer mount and aiming system shown in FIG. 17, where the sonar transducer mount and aiming system includes a rotating shaft comprising a length-adjustable longitudinal rail that is radially offset from and that runs parallel to an electric trolling motor shaft of the electric trolling motor;

FIG. 19 is another front perspective view of the exemplary sonar transducer mount and aiming system shown in FIG. 18, where the length-adjustable longitudinal rail of the rotating shaft is shown in an extended position;

FIG. 20 is another front perspective view of the exemplary sonar transducer mount and aiming system shown in FIG. 18, where the length-adjustable longitudinal rail of the rotating shaft is shown in a shortened position;

FIG. 21 is an exploded front perspective view of the exemplary sonar transducer mount and aiming system shown in FIG. 18;

FIG. 22 is a bottom front perspective view of the exemplary sonar transducer mount and aiming system shown in FIG. 18; and

FIG. 23 is an enlarged side perspective view of the length-adjustable longitudinal rail of the rotating shaft and clamp assembly shown in FIG. 22.

### DETAILED DESCRIPTION

Referring to the Figures, wherein like numerals indicate corresponding parts throughout the several views, a number of exemplary sonar transducer mount and aiming systems 100, 200, 300, 400, and 500 are illustrated.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

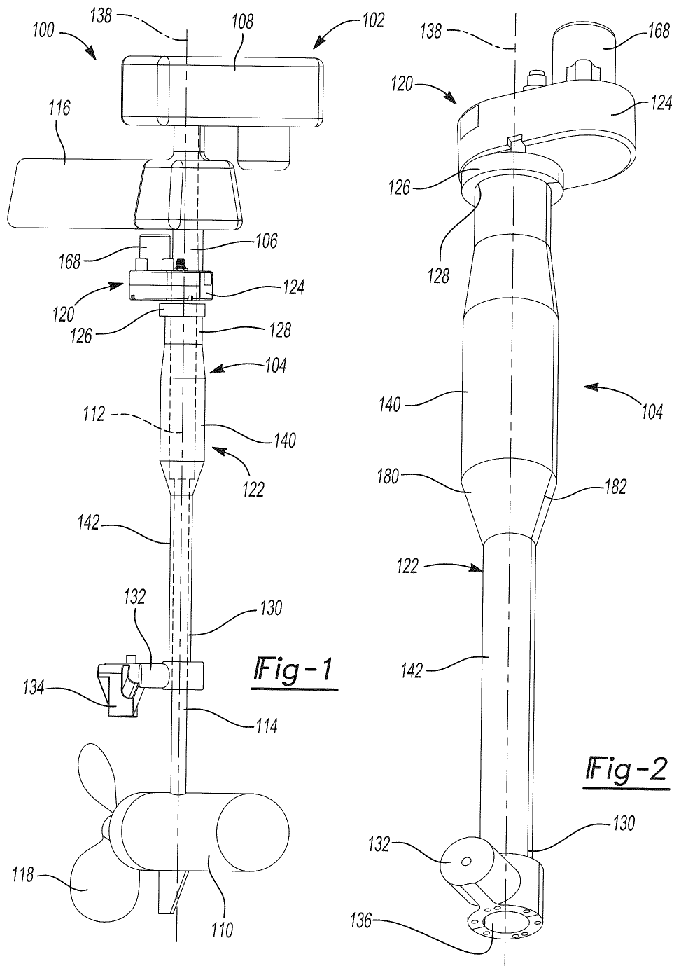

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device shown in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly. For the sole purpose of establishing a naming convention for spatially relative terms, the installed orientation of the device has been used, as illustrated in FIG. 1, where the electric trolling motor is in a deployed position. It should therefore be appreciated that in the deployed position, the trolling motor shaft is substantially vertical and the lower unit and propeller of the electric trolling motor are positioned below the head of the electric trolling motor. Additionally, the term “rotating” when used herein as part of an element name simply means that the element is capable of rotating and therefore does not mean that the element needs to be in the act of rotating or continuously rotating before the term applies.

FIG. 1 illustrates a system 100 comprising of an electric trolling motor 102 and a sonar transducer mount and aiming system 104. The electric trolling motor 102 includes an electric trolling motor shaft 106 that generally extends between a head 108 and a lower unit 110, both of which are connected to opposing ends of the electric trolling motor shaft 106. The electric trolling motor shaft 106 may be a two-piece shaft with an upper portion 112 and a lower portion 114 as shown, or alternatively may be a one-piece shaft. It should also be appreciated that the electric trolling motor shaft 106 may be made of metal or a graphite material, which may enable a certain degree of flex. In the illustrated example, the electric trolling motor 102 is a bow-mount trolling motor; however, it should be appreciated that the sonar transducer mount and aiming system 104 may find utility when installed on other types of electric trolling motors. In the illustrated example, the upper portion 112 of the electric trolling motor shaft 106 is rotatably fixed to a pivoting support arm 116 of the electric trolling motor 102. The pivot support arm 116 is pivotally connected to a base (not shown) that may be mounted to the bow of a boat. The pivot support arm 116 allows the electric trolling motor 102 to swing between a stowed position (not shown) where the electric trolling motor shaft 106 is substantially horizontal and a deployed position (shown in FIG. 1) where the electric trolling motor shaft 106 is substantially vertical. It should be appreciated that the deployed position is the use position of the electric trolling motor 102.

In the example shown in FIG. 1, the lower portion 114 of the electric trolling motor shaft 106 is connected to the lower unit 110 of the electric trolling motor 102 and can rotate relative to the upper portion 112 of the electric trolling motor shaft 106 to provide steering. Rotation of the lower portion 114 of the electric trolling motor shaft 106 may be provided by a mechanical steering system or an electric steering system (not shown), which may be controlled by a foot pedal, remote, or automated guidance (auto pilot) or anchoring system. If the electric trolling motor 102 has a one-piece shaft, the mechanical steering system or an electric steering system rotates the entire electric trolling motor shaft 106 relative to the pivot support arm 116 and may be controlled by a foot pedal, tiller, remote, or automated guidance (auto pilot) or anchoring system. Propulsion from the electric trolling motor 102 comes from an electric motor (not shown) housed in the lower unit 110, which drives rotation of a propeller 118, which generates thrust.

Still referring to FIG. 1, the sonar transducer mount and aiming system 104 includes a rotary actuator assembly 120 and a rotating shaft 122. The rotary actuator assembly 120 has a housing 124 that is fixedly secured to the electric trolling motor 102 and a rotating coupler 126 that is rotationally driven relative to the housing 124. The rotating shaft 122 extends between a first shaft end 128 that is connected to and rotates with the rotating coupler 126 of the rotary actuator assembly 120 and a second shaft end 130 that includes a sonar transducer mounting point 132. A sonar transducer 134 is mounted to the sonar transducer mounting point 132. The sonar transducer 134 may be a live scan sonar transducer, but could alternatively be a different type of sonar transducer that benefits from being rotated or aimed. For example, the sonar transducer 134 could alternatively be a scanning sonar transducer designed to provide 360 degrees of imaging as the transducer rotates.

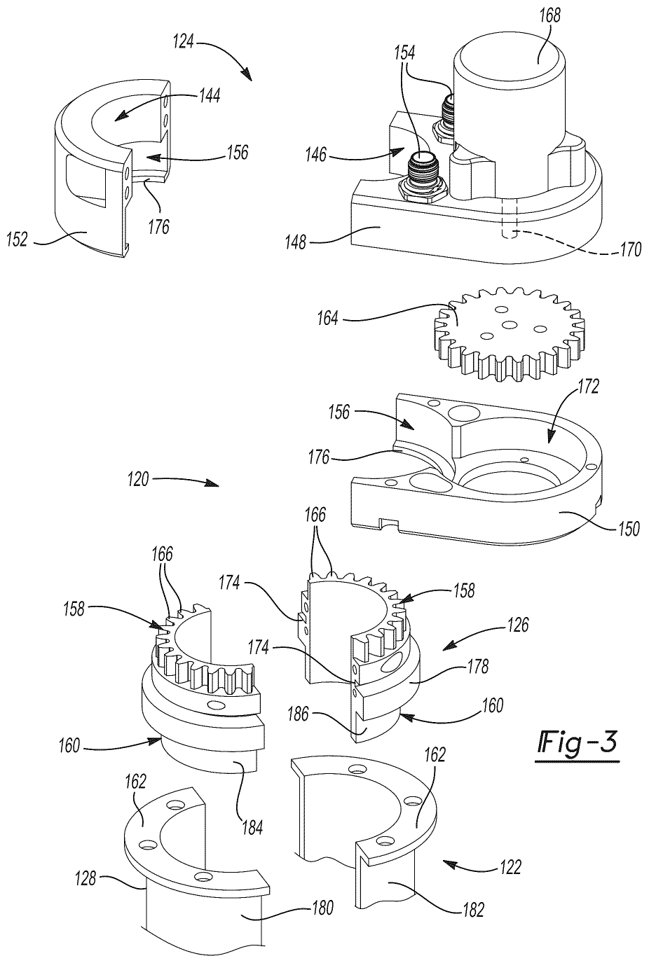

With additional reference now to FIGS. 2 and 3, the rotating shaft 122 has a tubular shape with a through bore 136 that runs the length of the rotating shaft 122 such that the through bore 136 is exposed and the rotating shaft 122 is open at the first and second shaft ends 128, 130. The size (i.e., dimensions) and shape of the through bore 136 in the rotating shaft 122 is configured to receive at least a portion of the electric trolling motor shaft 106 in a co-axial, shaft-over-shaft arrangement and a clearance fit such that the rotating shaft 122 of the sonar transducer mount and aiming system 104 and at least a portion of the electric trolling motor shaft 106 independently rotate about a common axis 138.

Optionally, the rotating shaft 122 may include a larger diameter section 140 that is sized to receive at least part of the upper portion 112 of the electric trolling motor shaft 106 and a smaller diameter section 142 that is sized to receive at least part of the lower portion 114 of the electric trolling motor shaft 106. Thus, the larger diameter section 140 may extend axially between the first shaft end 128 and the smaller diameter section 142 and the smaller diameter section 142 may extend axially between the larger diameter section 140 and the second shaft end 130. The rotating shaft 122 may be made of metal, graphite, or carbon fiber, for example, and the material and thickness of the rotating shaft 122 may be selected to match the rigidity or flex of the electric trolling motor shaft 106.

Although other configurations are possible, in the example shown in FIGS. 1-3, the housing 124 of the rotary actuator assembly 120 is fixedly secured to the upper portion 112 of the electric trolling motor shaft 106. For example, the housing 124 of the rotary actuator assembly 120 may include a pair of opposing jaws 144, 146 that are coupled to one another, by fasteners, for example, and clamp around the upper portion 112 of the electric trolling motor shaft 106 to fixedly secure the housing 124 in place. In particular, the housing 124 may be made of three pieces, an upper housing piece 148, a lower housing piece 150, and an end piece 152. In the illustrated example, the end piece 152 includes jaw 144 and the upper housing piece 148 includes jaw 146. Alternatively, or in addition to this clamp structure, the housing 124 of the rotary actuator assembly 120 may be fixedly secured to the pivoting support arm 116 of the electric trolling motor 102 by fasteners 154 and/or a bracket.

The housing 124 of the rotary actuator assembly 120 includes a first cavity 156 that receives a first portion 158 of the rotating coupler 126 and the rotating shaft 122 is coupled to a second portion 160 of the rotating coupler 126. In particular, the first shaft end 128 may include a shaft flange 162 that is fastened or otherwise secured to the second portion 160 of the rotating coupler 126. Optionally, the second portion 160 of the rotating coupler 126 may be positioned outside of the housing 124.

As best seen in FIG. 3, the rotary actuator assembly 120 includes a drive gear 164 and the first portion 158 of the rotating coupler 126 includes gear teeth 166 that are arranged in meshing engagement with the drive gear 164 such that rotation of the drive gear 164 drives rotation of the rotating coupler 126 relative to the housing 124. The rotary actuator assembly 120 includes an electric motor 168 with a drive shaft 170 that is coupled to and rotates with the drive gear 164 such that energization of the electric motor 168 drives rotation of the drive gear 164 relative to the housing 124. The housing 124 includes a second cavity 172 that receives the drive gear 164 and the first and second cavities 156, 172 within the housing 124 overlap where the gear teeth 166 on the first portion 158 of the rotating coupler 126 meshingly engage the drive gear 164.

In the illustrated example, the rotating coupler 126 includes an annular groove 174 between the first and second portions 158, 160 and the housing 124 of the rotary actuator assembly 120 includes an inwardly extending flange 176 that is received in the annular groove 174 in the rotating coupler 126 to prohibit axial movement of the rotating coupler 126 relative to the housing 124. In addition, the rotating coupler 126 in the illustrated example includes an annular shoulder 178 that abuts the shaft flange 162.

It should also be appreciated that in the example illustrated in FIGS. 1-3, the rotating shaft 122 has a split/clamshell arrangement with a first shaft half 180 and a second shaft half 182 that are fastened or otherwise secured to one another to collectively define the tubular shape of the rotating shaft 122 and the through bore 136. The rotating coupler 126 also has a split arrangement with a first coupler half 184 and a second coupler half 186 that are fastened or otherwise secured to one another to form a split driven gear, which has an annular or cylindrical shape. Advantageously, the split arrangement of the rotating shaft 122 and the rotating coupler 126 combined with the clamp arrangement of the housing 124 allows the sonar transducer mount and aiming system 104 to be easily installed over the electric trolling motor shaft 106 without disassembly of the electric trolling motor 102.

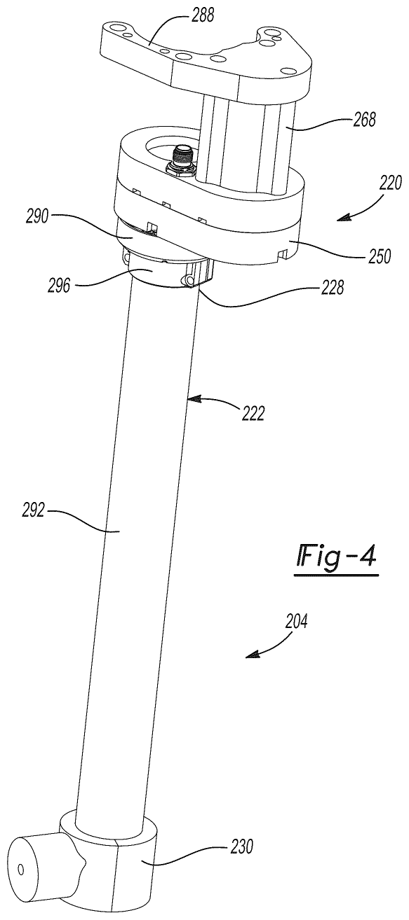

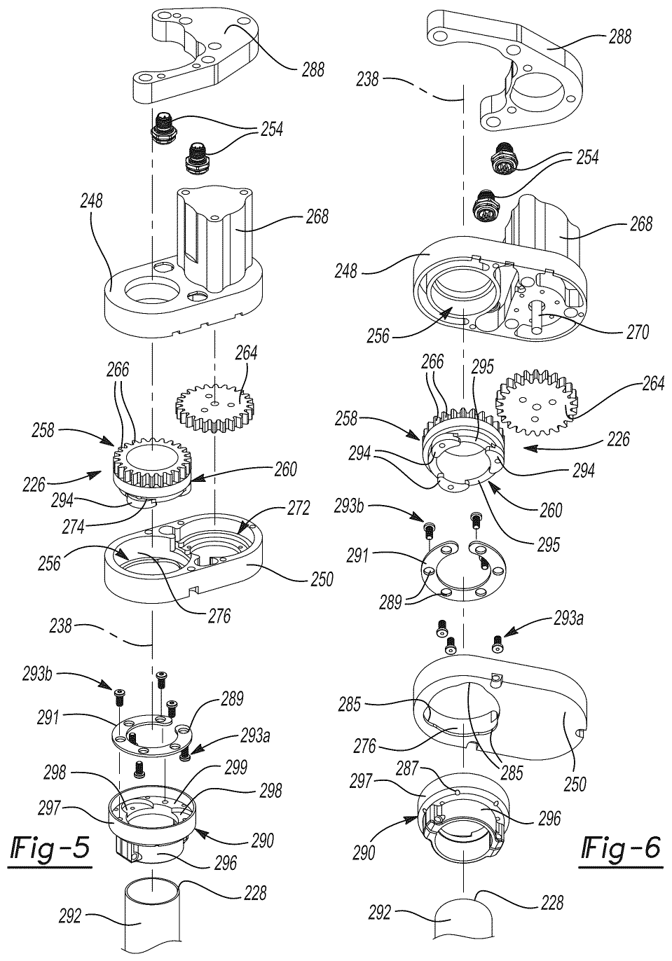

FIGS. 4-6 illustrate another sonar transducer mount and aiming system 204 that shares many of the same components as the sonar transducer mount and aiming system 104 illustrated in FIGS. 1-3, but in FIGS. 4-6 a one-piece rotating shaft 222 replaces the two-piece rotating shaft 122 illustrated in FIGS. 1-3. Rather than repeat the description set forth above, the following paragraphs describe the structure and function of the components in FIGS. 4-6 that are new and/or different from those shown and described in connection with FIGS. 1-3. It should be appreciated that the reference numbers in FIGS. 1-3 are “100” series numbers (e.g., 120, 122, 124, etc.) whereas the components in FIGS. 4-6 that are the same or similar to the components of the sonar transducer mount and aiming system 104 shown in FIGS. 1-3 share the same base reference numbers, but are listed as “200” series numbers (e.g., 220, 222, 224, etc.). Thus, the same description for element 120 above applies to element 220 in FIGS. 4-6 and so on and so forth.

The sonar transducer mount and aiming system 204 illustrated in FIGS. 4-6 also includes a rotary actuator assembly 220 and a rotating shaft 222. The rotary actuator assembly 220 has a housing 224 that is fixedly secured to the electric trolling motor 102 and a rotating coupler 226 that is rotationally driven relative to the housing 224. The rotating shaft 222 extends between a first shaft end 228 that is connected to and rotates with the rotating coupler 226 of the rotary actuator assembly 220 and a second shaft end 230 that includes a sonar transducer mounting point 232. The rotating shaft 222 has a tubular shape with a through bore 236 that runs the length of the rotating shaft 222. The size (i.e., dimensions) and shape of the through bore 236 in the rotating shaft 222 is configured to receive at least a portion of the electric trolling motor shaft 106 in a co-axial, shaft-over-shaft arrangement and a clearance fit such that the rotating shaft 222 of the sonar transducer mount and aiming system 204 is free to rotate independently of the electric trolling motor shaft 106.

In the example shown in FIGS. 4-6, the housing 224 of the rotary actuator assembly 220 is fixedly secured to the pivoting support arm 116 of the electric trolling motor 102 by fasteners 254 and/or a bracket 288. The housing 224 in this example is made of two pieces, an upper housing piece 248 and a lower housing piece 250. The housing 224 of the rotary actuator assembly 220 includes a first cavity 256 that receives a first portion 258 of the rotating coupler 226 and the rotating shaft 222 is coupled to a second portion 260 of the rotating coupler 226 by a collar 290. In particular, the second portion 260 of the rotating coupler 226 is positioned outside of the housing 224, the collar 290 clamps onto the first shaft end 228, and a flex disc 291 that is positioned between and bolts to the rotating coupler 226 and the collar 290 using fasteners 293a, 293b.

The rotary actuator assembly 220 includes a drive gear 264 and the first portion 258 of the rotating coupler 226 includes gear teeth 266 that are arranged in meshing engagement with the drive gear 264 such that rotation of the drive gear 264 drives rotation of the rotating coupler 226 relative to the housing 224. The rotary actuator assembly 220 includes an electric motor 268 with a drive shaft 270 that is coupled to and rotates with the drive gear 264 such that energization of the electric motor 268 drives rotation of the drive gear 264 relative to the housing 224. The housing 224 includes a second cavity 272 that receives the drive gear 264 and the first and second cavities 256, 272 within the housing 224 overlap where the gear teeth 266 on the first portion 258 of the rotating coupler 226 meshingly engage the drive gear 264.

In the illustrated example, the rotating coupler 226 includes an annular groove 274 between the first and second portions 258, 260 and the housing 224 of the rotary actuator assembly 220 includes an inwardly extending flange 276 that is received in the annular groove 274 in the rotating coupler 226 to prohibit axial movement of the rotating coupler 226 relative to the housing 224.

The rotating shaft 222 of the sonar transducer mount and aiming system 204 shown in FIGS. 4-6 includes a one-piece tubular segment 292 that extends between the first and second shaft ends 228, 230. The second portion 260 of the rotating coupler 226 includes a plurality of lobes 294 that are adjacent to and define part of the annular groove 274 and a plurality of valleys 295 that are positioned between the lobes 294. The inwardly extending flange 276 includes a plurality of cut-outs 285 that have the same shape and spacing as the lobes 294 on the rotating coupler 226 so that the lobes 294 can pass through the inwardly extending flange 276 of the housing 224 during assembly or disassembly. The rotating shaft 222 is coupled to the second portion 260 of the rotating coupler 226 by the collar 290, which includes a clamp portion 296 that clamps onto the first shaft end 228 and a cup portion 297 that receives the flex disc 291 and the second portion 260 of the rotating coupler 226. The collar 290 includes a plurality of pockets 298 that are radially offset from the lobes 294 on the second portion 260 of the rotating coupler 226 and a plurality of buttresses 299 that are positioned between the pockets 298 and are aligned with the lobes 294 on the rotating coupler 226. The flex disc 291 bolts to the rotating coupler 226 using a first group of fasteners 293a that extend up through the flex disc 291 and thread into holes in the lobes 294 on the second portion 260 of the rotating coupler 226. The flex disc 291 bolts to the collar 290 using a second group of fasteners 293b that extend down through the flex disc 291 and thread into holes in the buttresses 299 in the collar 290. Tool access to the first group of fasteners 293a may be provided by through-holes 287 that extend through the collar 290 and are aligned with the heads of the first group of fasteners 293a. Once assembled, the collar 290 and rotating shaft 222 rotate together with the rotating coupler 226. The flex disc 291 is design to flex to allow the rotating shaft 222 to flex with the electric trolling motor shaft 106. The flex disc 291 is made of the thin and flexible material and has a flat C-shape with a split/gap between opposing ends. For example, the flex disc 291 may be 3/32 inches thick and made of acetal plastic. The valleys 295 between the lobes 294 on the rotating coupler 226 and the pockets 298 between the buttresses 299 on the collar 290 provide clearance gaps that give portions of the flex disk 291 room to bend and flex. Optionally, resilient grommets 289 may be placed between the fasteners 293a, 293b and the flex disc 291 to increase the degree of articulation (range of movement) permitted by the connection between the rotating shaft 222 and the rotating coupler 226.

It should be appreciated that the sonar transducer mount and aiming system 204 shown in FIGS. 4-6 provides a solution for electric trolling motors 102 that have an electric trolling motor shaft 106 that can easily be removed and disconnected from the head 108 or the lower unit 110 so that the electric trolling motor shaft 106 can be slid through the second cavity 272 of the housing, the rotating coupler 126, the collar 290, and the through bore 236 in the rotating shaft 222 during installation or removal of the sonar transducer mount and aiming system 204.

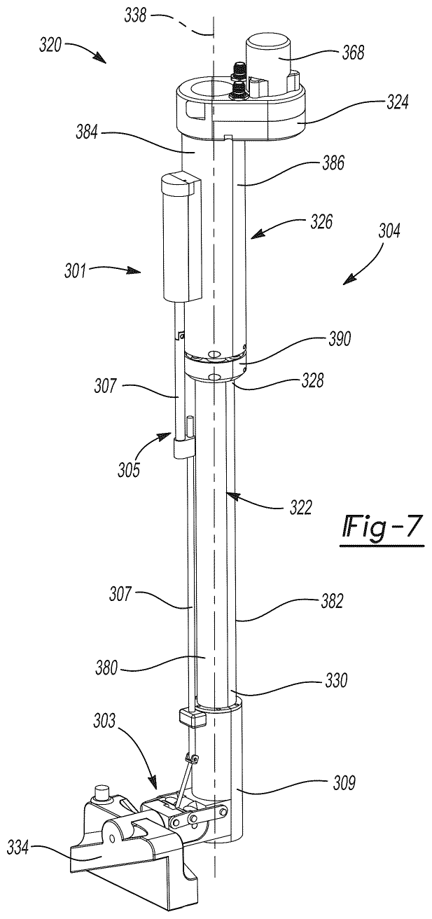

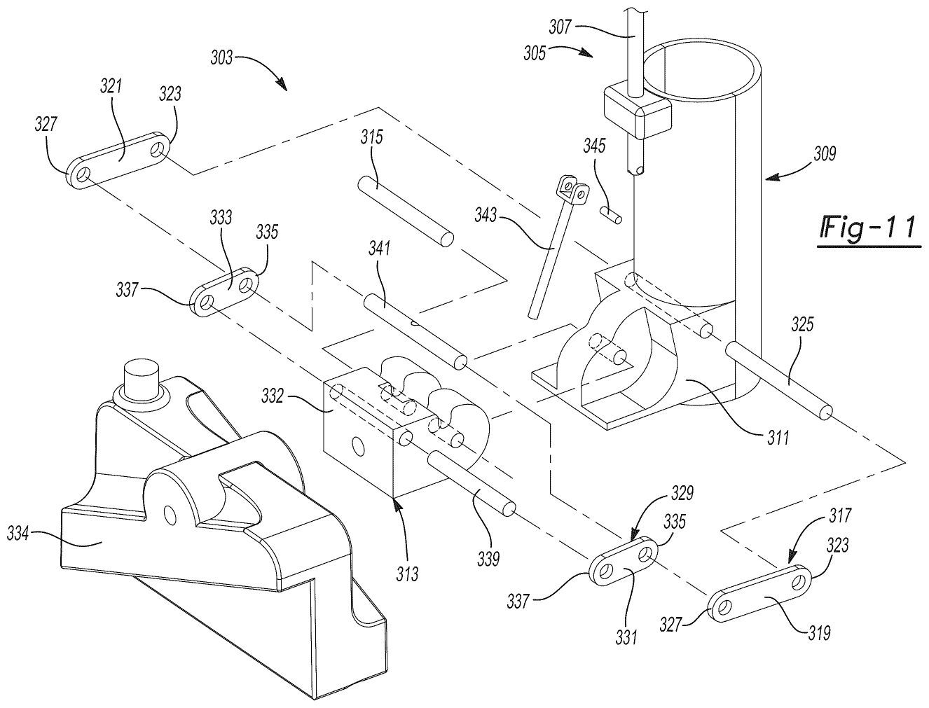

FIGS. 7-13 illustrate another sonar transducer mount and aiming system 304 that shares many of the same components as the sonar transducer mount and aiming system 104 illustrated in FIGS. 1-3, but in FIGS. 7-13 the sonar transducer mount and aiming system 304 includes a remote linear actuator 301 that actuates an articulating transducer bracket assembly 303. Rather than repeat the description set forth above, the following paragraphs describe the structure and function of the components in FIGS. 7-13 that are new and/or different from those shown and described in connection with FIGS. 1-3. It should be appreciated that the reference numbers in FIGS. 1-3 are “100” series numbers (e.g., 120, 122, 124, etc.) whereas the components in FIGS. 7-13 that are the same or similar to the components of the sonar transducer mount and aiming system 104 shown in FIGS. 1-3 share the same base reference numbers, but are listed as “300” series numbers (e.g., 320, 322, 324, etc.). Thus, the same description for element 120 above applies to element 320 in FIGS. 7-13 and so on and so forth.

The sonar transducer mount and aiming system 304 illustrated in FIGS. 7-9 also includes a rotary actuator assembly 320 and a rotating shaft 322. The rotary actuator assembly 320 has a housing 324 that is fixedly secured to the electric trolling motor 302 and a rotating coupler 326 that is rotationally driven relative to the housing 324. In the illustrated embodiment, the rotating coupler 326 is elongated and defines a larger diameter section 340 that is sized to receive the upper portion 112 of the electric trolling motor shaft 106. The rotating shaft 322 defines a smaller diameter section 342 that is sized to receive at least part of the lower portion 114 of the electric trolling motor shaft 106. The rotating shaft 322 extends between a first shaft end 328 that is connected to and rotates with the rotating coupler 326 of the rotary actuator assembly 320 and a lower shaft end 330 that includes a sonar transducer mounting point 332. A sonar transducer 334 is mounted to the sonar transducer mounting point 332.

The rotating shaft 322 has a tubular shape with a through bore 336 that runs the length of the rotating shaft 322. The size (i.e., dimensions) and shape of the through bore 336 in the rotating shaft 322 is configured to receive the lower portion 114 of the electric trolling motor shaft 106 in a co-axial, shaft-over-shaft arrangement and a clearance fit such that the rotating shaft 322 of the sonar transducer mount and aiming system 304 and the lower portion 114 of the electric trolling motor shaft 106 can independently rotate relative to one another.

In the example shown in FIGS. 7-9, the housing 324 of the rotary actuator assembly 320 is fixedly secured to the upper portion 112 of the electric trolling motor shaft 106. The housing 324 of the rotary actuator assembly 320 includes a pair of opposing jaws 344, 346 that are coupled to one another, by fasteners, for example, and clamp around the upper portion 112 of the electric trolling motor shaft 106 to fixedly secure the housing 324 in place. In particular, the housing 324 is made of three pieces, an upper housing piece 348, a lower housing piece 350, and an end piece 352. In the illustrated example, the end piece 352 includes jaw 344 and the upper housing piece 348 includes jaw 346. Alternatively, or in addition to this clamp structure, the housing 312 of the rotary actuator assembly 320 may be fixedly secured to the pivoting support arm 116 of the electric trolling motor 102 by fasteners 354 and/or a bracket like the bracket 288 shown in FIGS. 4-6.

The housing 324 of the rotary actuator assembly 320 shown in FIGS. 7-9 includes a first cavity 356 that receives a first portion 358 of the rotating coupler 326 and the rotating shaft 322 is coupled to a second portion 360 of the rotating coupler 326 by a collar 390 and flex disc 391. In particular, the first shaft end 328 may include a shaft flange 362 that is fastened or otherwise secured to the collar 390. Both the collar 390 and the second portion 360 of the rotating coupler 326 are positioned outside of the housing 324 in this example the flex disc 391 bolts to both the second portion 360, the rotating coupler 326, and the collar 390 using fasteners 393a, 393b.

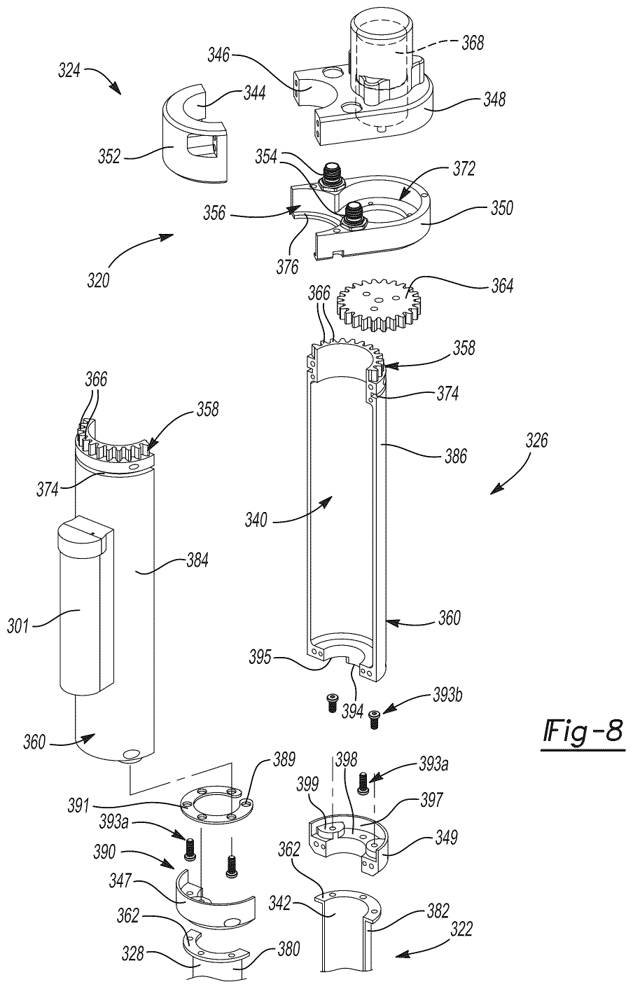

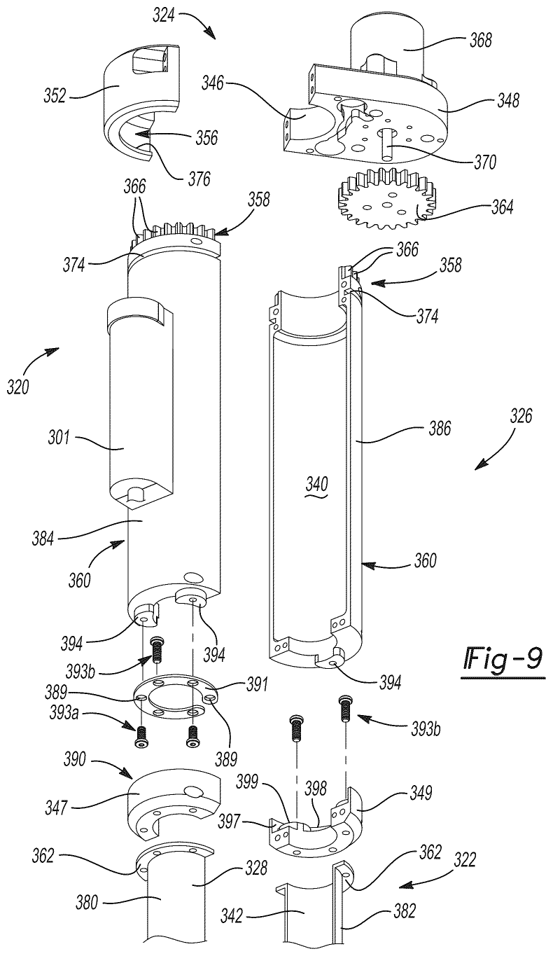

As best seen in FIGS. 8 and 9, the rotary actuator assembly 320 includes a drive gear 364 and the first portion 358 of the rotating coupler 326 includes gear teeth 366 that are arranged in meshing engagement with the drive gear 364 such that rotation of the drive gear 364 drives rotation of the rotating coupler 326 relative to the housing 324. The rotary actuator assembly 320 includes an electric motor 368 with a drive shaft 370 that is coupled to and rotates with the drive gear 364 such that energization of the electric motor 368 drives rotation of the drive gear 364 relative to the housing 324. The housing 324 includes a second cavity 372 that receives the drive gear 364 and the first and second cavities 356, 372 within the housing 324 overlap where the gear teeth 366 on the first portion 358 of the rotating coupler 326 meshingly engage the drive gear 364.

In the illustrated example, the rotating coupler 326 includes an annular groove 374 between the first and second portions 358, 360 and the housing 324 of the rotary actuator assembly 320 includes an inwardly extending flange 376 that is received in the annular groove 374 in the rotating coupler 326 to prohibit axial movement of the rotating coupler 326 relative to the housing 324. The second portion 360 of the rotating coupler 326 includes a plurality of lobes 394 and a plurality of valleys 395 that are positioned between the lobes 394. The lobes 394 are adjacent to and define part of the annular groove 374 in the rotating coupler 326. The rotating shaft 322 is coupled to the second portion 360 of the rotating coupler 326 by the collar 390 and flex disc 391. The collar 390 includes a cup portion 397 that receives the flex disc 391 and the lobes 394 on the second portion 360 of the rotating coupler 326. The collar 390 also includes a plurality of pockets 398 that are radially offset from the lobes 394 on the second portion 360 of the rotating coupler 326 and a plurality of buttresses 399 that are positioned between the pockets 398 and are aligned with the lobes 394 on the rotating coupler 326. The flex disc 391 bolts to the rotating coupler 326 using a first group of fasteners 393a that extend up through the flex disc 391 and thread into holes in the lobes 394 on the second portion 360 of the rotating coupler 326. The flex disc 391 bolts to the collar 390 using a second group of fasteners 393b that extend down through the flex disc 391 and thread into holes in the buttresses 399 in the collar 390. Tool access to the first group of fasteners 393a may be provided by through-holes 387 that extend through the collar 390 and are aligned with the heads of the first group of fasteners 393a. Once assembled, the collar 390 and rotating shaft 322 rotate together with the rotating coupler 326 and the rotating shaft 322 can still flex with the electric trolling motor shaft 106. The valleys 395 between the lobes 394 on the rotating coupler 326 and the pockets 398 between the buttresses 399 on the collar 390 provide clearance gaps that give portions of the flex disk 391 room to bend and flex and resilient grommets 389 are placed between the fasteners 393a, 393b and the flex disc 391 to increase the degree of articulation (range of movement) permitted by the connection between the rotating shaft 322 and the rotating coupler 326.

It should also be appreciated that in the example illustrated in FIGS. 7-9, the rotating shaft 322 has a split arrangement with a first shaft half 380 and a second shaft half 382 that are fastened or otherwise secured to one another to collectively define the tubular shape of the rotating shaft 322 and the through bore 336. The rotating coupler 326 also has a split arrangement with a first coupler half 384 and a second coupler half 386 that are fastened or otherwise secured to one another to form an annular or cylindrical shape. The collar 390 also has a split arrangement with a first collar half 347 and the second collar half 349 that are fastened or otherwise secured to one another. Advantageously, the split/clamshell arrangement of the rotating shaft 322 and the rotating coupler 326 combined with the clamp arrangement of the housing 324 allows the sonar transducer mount and aiming system 304 to be easily installed over the electric trolling motor shaft 106 without disassembly of the electric trolling motor 102.

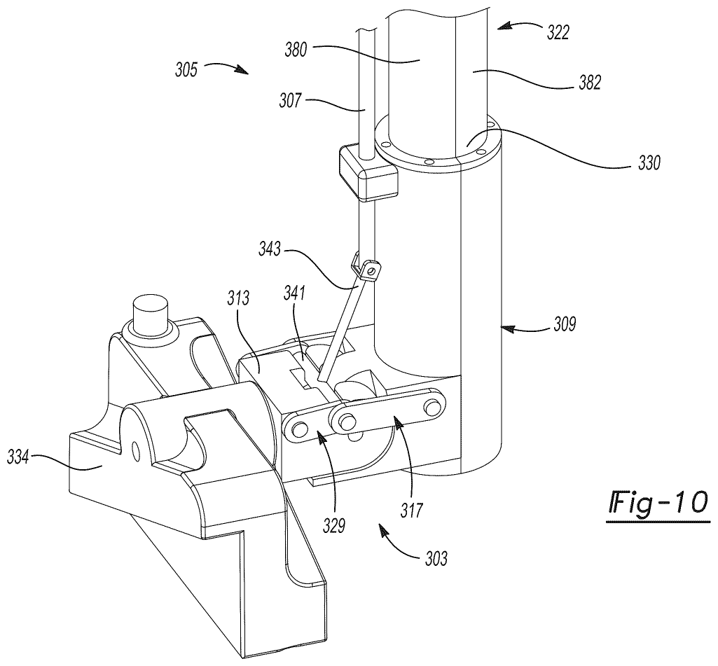

With additional reference now to FIGS. 10-13, the sonar transducer mount and aiming system 304 also includes a linear actuator 301 and an articulating transducer bracket assembly 303, which is coupled to the linear actuator 301 by a push-pull actuator 305. The push-pull actuator 305 may be one or more rods 307 as shown in the illustrated example, or alternatively could be a push-pull cable or a sliding tube positioned over or inside of the rotating shaft 322 in a co-axial arrangement. Regardless of type, the push-pull actuator 305 is mounted to and rotates with the rotating shaft 322 but is free to slide axially relative to the rotating shaft 322 between an extended position and a retracted position. The push-pull actuator 305 is connected at one end to the linear actuator 301, which operates to move the push-pull actuator 305 between the extended and retracted positions. Although other configurations are possible, in the illustrated example, the linear actuator 301 is mounted to and rotates with the rotating coupler 326 at a position that is designed to be above the waterline. In one non-limiting alternative, the linear actuator 301 could be mounted to the rotating shaft 322.

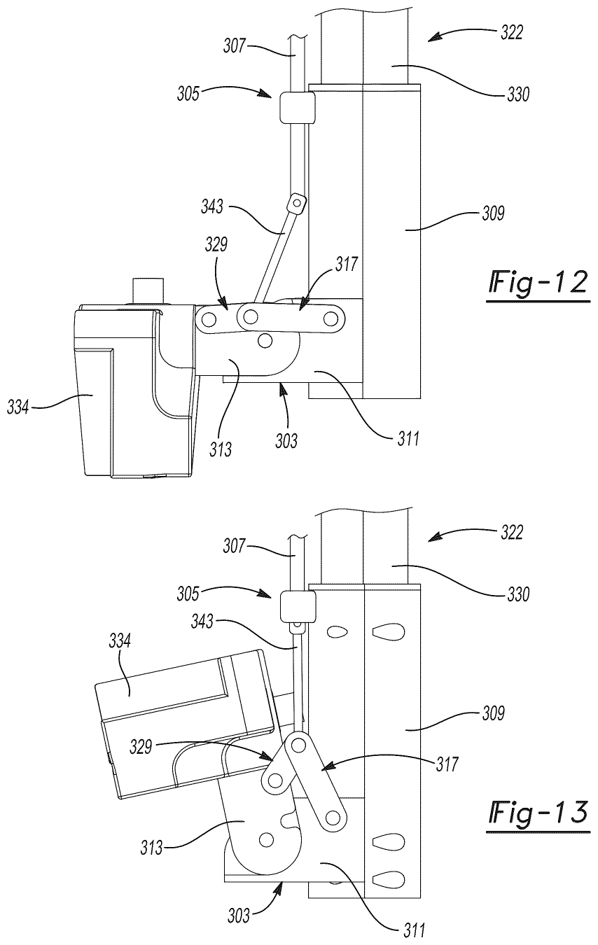

The lower shaft end 330 of the rotating shaft 322 may include a foot 309 with a pivot leaf 311 that projects radially outwardly from the foot 309. The foot 309 may have a split arrangement like rotating shaft 322 or may alternatively be one-piece like rotating shaft 222. The articulating transducer bracket assembly 303 in the illustrated example includes a bracket arm 313 that is configured to support the sonar transducer 334 at a sonar transducer mounting point 332 and is pivotally mounted to the pivot leaf 311 on the lower shaft end 330 by a first pin 315. The articulating transducer bracket assembly 303 includes an inboard linkage 317 comprising a first link 319, and optionally a second link 321, on opposing sides of the bracket arm 313. Each of the first and second links 319, 321 of the inboard linkage 317 has a first link end 323 that is pivotally mounted to the foot 309 at the lower shaft end 330 by a second pin 325 and a second link end 327 opposite the first link end 323. The articulating transducer bracket assembly 303 also includes an outboard linkage 329 comprising a third link 331, and optionally a fourth link 333, on opposing sides of the bracket arm 313. Each of the third and fourth links 331, 333 of the outboard linkage 329 has a third link end 335 and a fourth link end 337 opposite the third link end 335. The fourth link end 337 of each of the third and fourth links 331, 333 is pivotally connected to the bracket arm 313 by a third pin 339. The articulating transducer bracket assembly 303 further includes a drive pin 341 that pivotally couples the second link end 327 of each of the first and second links 319, 321 of the inboard linkage 317 to the third link end 335 of each of the third and fourth links 331, 333 of the outboard linkage 329. The rod 307 of the push-pull actuator 305 is coupled to the drive pin 341 by a connected rod 343 and a fourth pin 345 such that the bracket arm 313 pivots between a down/forward scanning position (as shown in FIG. 12) when the push-pull actuator 305 is in the extended position and a perspective scanning position (as shown in FIG. 13) when the push-pull actuator 305 is in the retracted position. Advantageously, the orientation and therefore the scanning mode of the sonar transducer can be changed with the push of a button and while the sonar transducer is in use (i.e., when the electric trolling motor 102 is deployed and the sonar transducer is under water).

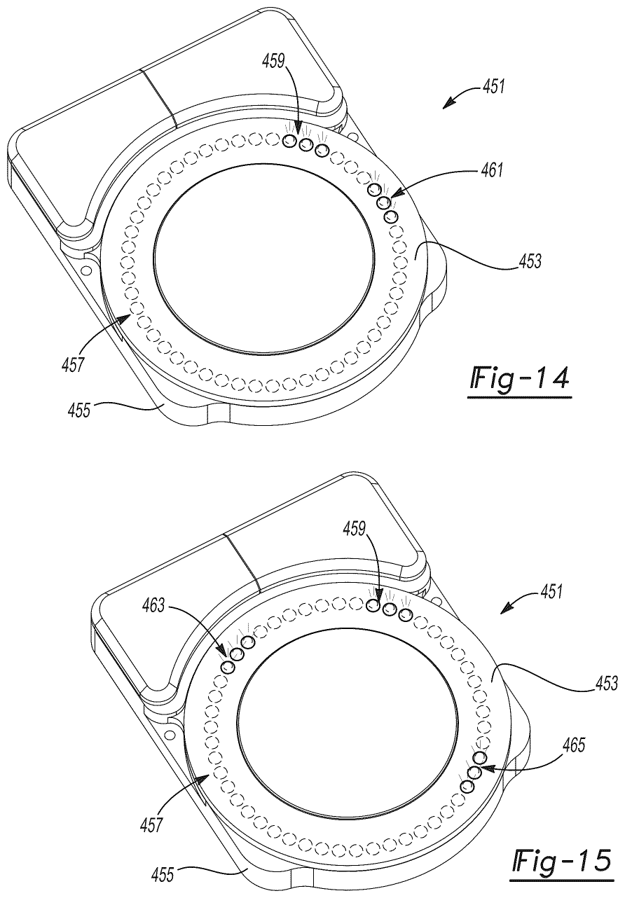

FIGS. 14 and 15 illustrate a control pedal 451 that is designed to control any one of the sonar transducer mounts and aiming systems 104, 204, 304 described above. The control pedal 451 is electronically connected to the electric motor 168, 268, 368 of the rotary actuator assembly 120, 220, 320, either directly, or through a control circuit, which may include one or more controllers, processors, and power supplies. It should also be appreciated that the electronic connection between the control pedal 451 and the electric motor 168, 268, 368 of the rotary actuator assembly 120, 220, 320 may be through a wired connection or a wireless connection. The control pedal 451 includes a rotary dial 453 that is rotatably mounted to a base 455 of the control pedal 451. The rotary dial 453 is used to set and adjust a rotational position of the rotating shaft 122, 222, 322 and therefore a heading associated with the sonar transducer mounting point 132, 232, 332, which also corresponds to the heading of the sonar transducer 134, 234, 334 (i.e., the direction in which the sonar transducer 134, 234, 334 is aiming).

As shown in FIG. 14, the rotary dial 453 includes ring of indicator lights 457 that provide a first illuminated heading 459 that corresponds with the heading associated with the sonar transducer mounting point 132, 232, 332 and a second illuminated heading 461 that corresponds with a user selected heading. The control circuit energizes the electric motor 168, 268, 368 of the rotary actuator assembly 120, 220, 320 to rotate the rotating shaft 122, 222, 322 in a clockwise rotational direction or a counterclockwise rotational direction until the first illuminated heading 459 (corresponding with the heading associated of the sonar transducer mounting point 132, 232, 332) matches the second illuminated heading 461 (corresponding with the user selected heading). Thus, the rotary dial 453 allows a user to quickly set a desired transducer heading (the user selected heading displayed as the second illuminated heading 461) and the electric motor 168, 268, 368 of the rotary actuator assembly 120, 220, 320 will continue to turn the rotating shaft 122, 222, 322 until the heading of the sonar transducer mounting point 132, 232, 332 (displayed as the first illuminated heading 459) reaches the desired transducer heading (displayed as the second illuminated heading 461) without any additional input from the user, allowing the user to focus elsewhere as the aiming operation (i.e., rotation) is completed.

As shown in FIG. 15, the ring of indicator lights 457 provides a first illuminated pan limit 463 and a second illuminated pan limit 465 that are user selectable and that define two radial limits for an automated sweep operating mode where the control circuit energizes the electric motor 168, 268, 368 of the rotary actuator assembly 120, 220, 320 to rotate the rotating shaft 122, 222, 322 in a clockwise rotational direction and then a counterclockwise rotational direction so that the heading of the sonar transducer mounting point 132, 232, 332 (displayed as the first illuminated heading 459) sweeps back and forth between the first and second illuminated pan limits 463, 465. The control pedal 451, which may be configured to be foot operated, also provides the ability to change the rotational speed of the rotating shaft 122, 222, 322 during the automated sweep operating mode and/or during normal operational control (i.e., a manual operating mode), such as that illustrated in FIG. 14. Optionally, the ring of indicator lights 457 may be LEDs that are configured to change color and the first and second illuminated headings 459, 461 and/or the first and second illuminated pan limits 463, 465 may be designated by different colors when illuminated.

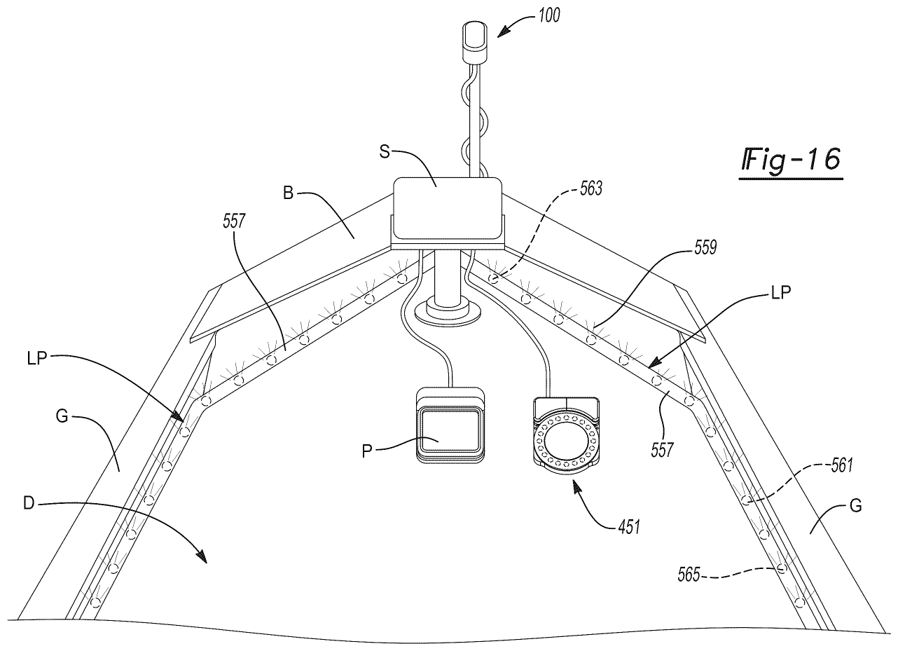

FIG. 16 illustrates an embodiment where the ring of indicator lights 457 on the control pedal 451 shown in FIG. 15 is replaced or augmented by an array of indicator lights 557 mounted along a lighted perimeter LP of a boat B. As shown in FIG. 16, the control pedal 451 for the sonar transducer mounts and aiming systems 104, 204, 304 may be separate from the foot pedal P that controls the electric trolling motor 100. Alternatively, the control pedal 451 could be integrated with or attached to the foot pedal P that controls the electric trolling motor 100. The lighted perimeter LP about which the array of indicator lights 557 are arranged extends around at least a portion of a casting deck D or gunnel G of the boat B. Like the ring of indicator lights 457 on the control pedal 451, the array of indicator lights 557 mounted along the lighted perimeter LP of the boat B provide a first illuminated heading 559 that corresponds with the heading associated with the sonar transducer mounting point 132, 232, 332. Because the array of indicator lights 557 extend around the casting deck D or gunnel G of the boat B, an angler can directly visualize the direction in which the sonar transducer mounting point 132, 232, 332 and therefore the transducer 134 is pointed, which makes it easier for the angler to cast a bait in that same direction so that it falls within the sonar beam emitted by the transducer 134 and shows up on the sonar screen S. This feature is particularly useful because live sonar systems currently on the market typically have transducers 134 that emit a relatively narrow sonar beam, so it can be difficult for anglers to consistently cast a bait within the sonar beam so that the bait is displayed on the sonar screen S (along with nearby structure and fish reacting to the bait).

As discussed above, the control circuit may include a manual operating mode and an automated sweep operating mode. In the manual operating mode, the array of indicator lights 557 may provide a second illuminated heading 561 that corresponds with a user selected heading. In a manual operating, the control circuit energizes the electric motor 168, 268, 368 of the rotary actuator assembly 120, 220, 320 to rotate the rotating shaft 122, 222, 322 in a clockwise rotational direction or a counterclockwise rotational direction until the first illuminated heading 559 (corresponding with the heading associated of the sonar transducer mounting point 132, 232, 332) matches the second illuminated heading 561 (corresponding with the user selected heading). Thus, the array of indicator lights 557 allows a user to quickly set a desired transducer heading (the user selected heading displayed as the second illuminated heading 561) and the electric motor 168, 268, 368 of the rotary actuator assembly 120, 220, 320 will continue to turn the rotating shaft 122, 222, 322 until the heading of the sonar transducer mounting point 132, 232, 332 (displayed as the first illuminated heading 559) reaches the desired transducer heading (displayed as the second illuminated heading 561) without any additional input from the user, allowing the user to focus elsewhere as the aiming operation (i.e., rotation) is completed.

In the automated sweep operating mode, the array of indicator lights 557 provides a first illuminated pan limit 563 and a second illuminated pan limit 565 that are user selectable and that define two radial limits where the control circuit energizes the electric motor 168, 268, 368 of the rotary actuator assembly 120, 220, 320 to rotate the rotating shaft 122, 222, 322 in a clockwise rotational direction and then a counterclockwise rotational direction so that the heading of the sonar transducer mounting point 132, 232, 332 (displayed as the first illuminated heading 559) sweeps back and forth between the first and second illuminated pan limits 563, 565. The control pedal 551, which may be configured to be foot operated, also provides the ability to change the rotational speed of the rotating shaft 122, 222, 322 during the automated sweep operating mode and/or during the manual operating mode. Optionally, the array of indicator lights 557 may be a light strip, rope light, or cord of LEDs that are configured to change color and the first and second illuminated headings 559, 561 and/or the first and second illuminated pan limits 563, 565 may be designated by different colors when illuminated.

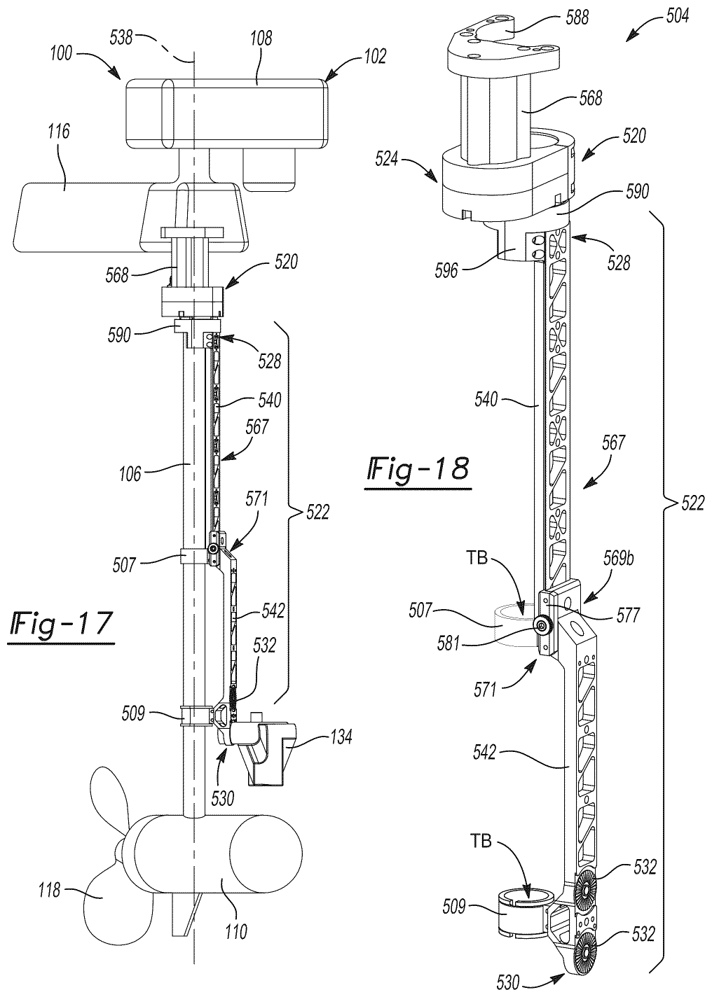

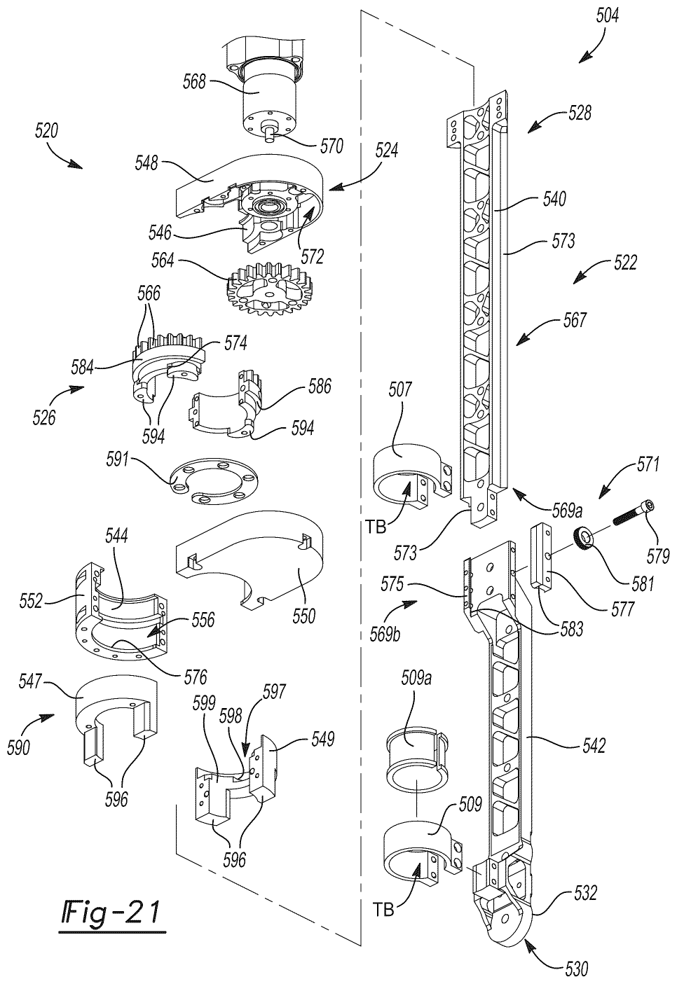

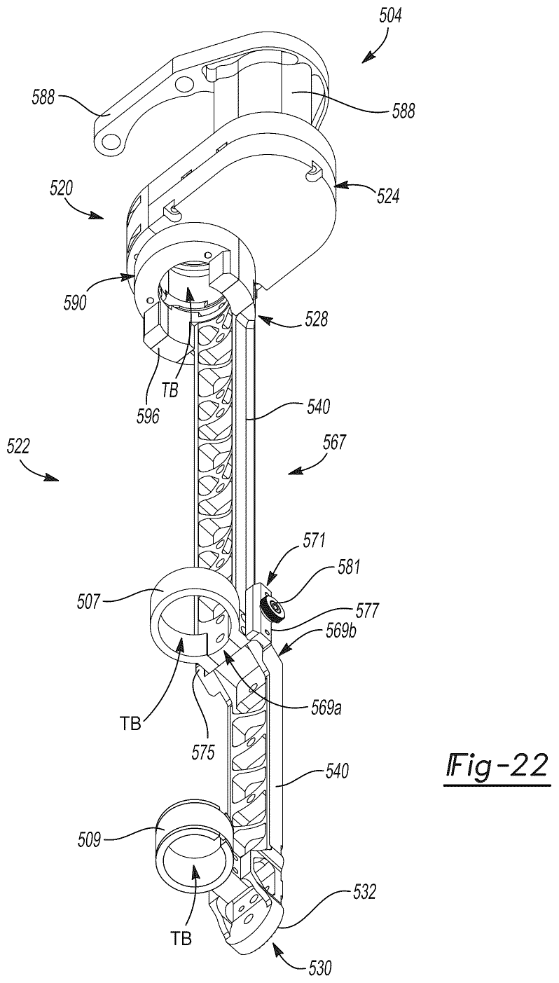

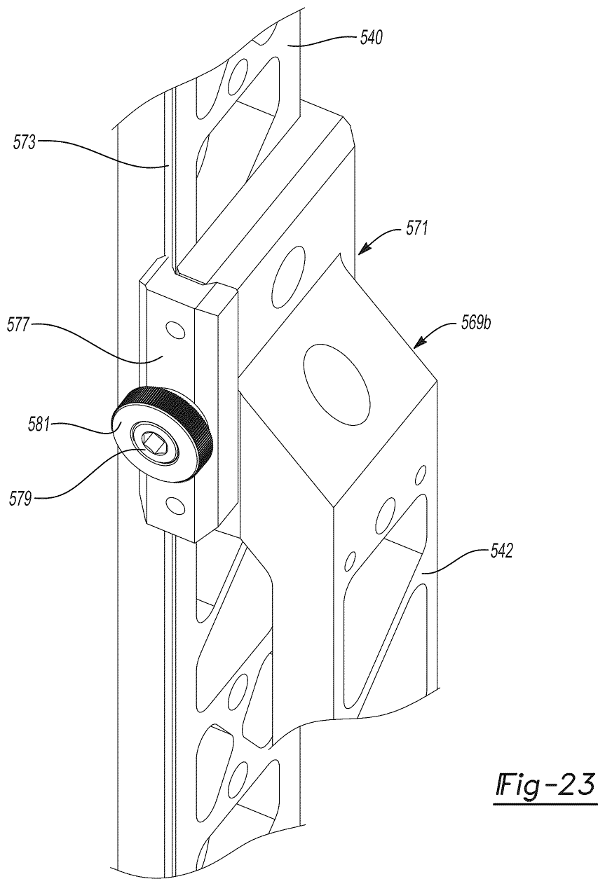

FIGS. 17-23 illustrate another sonar transducer mount and aiming system 504 that shares many of the same components as the sonar transducer mount and aiming systems 104, 204, 304 illustrated in FIGS. 1-13, but in FIGS. 17-23 the sonar transducer mount and aiming system 504 includes a length-adjustable (i.e., telescopic) rotating shaft 522 that is radially offset from and parallel to the electric trolling motor shaft 106. Rather than repeat the description set forth above, the following paragraphs describe the structure and function of the components in FIGS. 17-23 that are new and/or different from those shown and described in connection with FIGS. 1-13. It should be appreciated that the reference numbers in FIGS. 1-13 are “100” series numbers (e.g., 120, 122, 124, etc.), “200” series numbers (e.g., 220, 222, 224, etc.), and “300” series numbers (e.g., 320, 322, 324, etc.) whereas the components in FIGS. 17-23 that are the same or similar to the components of the sonar transducer mount and aiming systems 104, 204, 304 shown in FIGS. 1-13 share the same base reference numbers, but are listed as “500” series numbers (e.g., 520, 522, 524, etc.). Thus, the same description for elements 120, 220, and 320 above applies to element 520 in FIGS. 17-23 and so on and so forth.

The sonar transducer mount and aiming system 504 illustrated in FIGS. 17-23 includes a rotary actuator assembly 520 and a rotating shaft 522. The rotary actuator assembly 520 has a housing 524 that is fixedly secured to the electric trolling motor 102 and a rotating coupler 526 that is rotationally driven relative to the housing 524. The rotating shaft 522 and the electric trolling motor shaft 106 have a common axis of rotation 538 and are independently rotatable about the common axis of rotation 538. As will be appreciated from FIG. 17, the common axis of rotation 538 is co-axial with and runs longitudinally down the middle of the electric trolling motor shaft 106 and therefore forms a centerline of the electric trolling motor shaft 106.

The rotating shaft 522 includes a longitudinal bar 567 that is radially offset from and runs parallel to the electric trolling motor shaft 106 such that the longitudinal bar 567 rotates in an orbit about the common axis of rotation 538. The longitudinal bar 567 of the rotating shaft 522 generally extends from a first shaft end 528 to a second shaft end 530. The rotating shaft 522 also includes an upper collar 590 that rotatably couples the first shaft end 528 of the longitudinal bar 567 to the rotating coupler 526. As a result, rotation of the rotating coupler 526 within the housing 524 causes the longitudinal bar 567 of the rotating shaft 522 to rotate about the common axis of rotation 538 for both the electric trolling motor shaft 106 and the rotating shaft 522 of the sonar transducer mount and aiming system 504. A transducer mounting point 532 is provided on the second shaft end 530 to which a sonar transducer 134 is mounted.

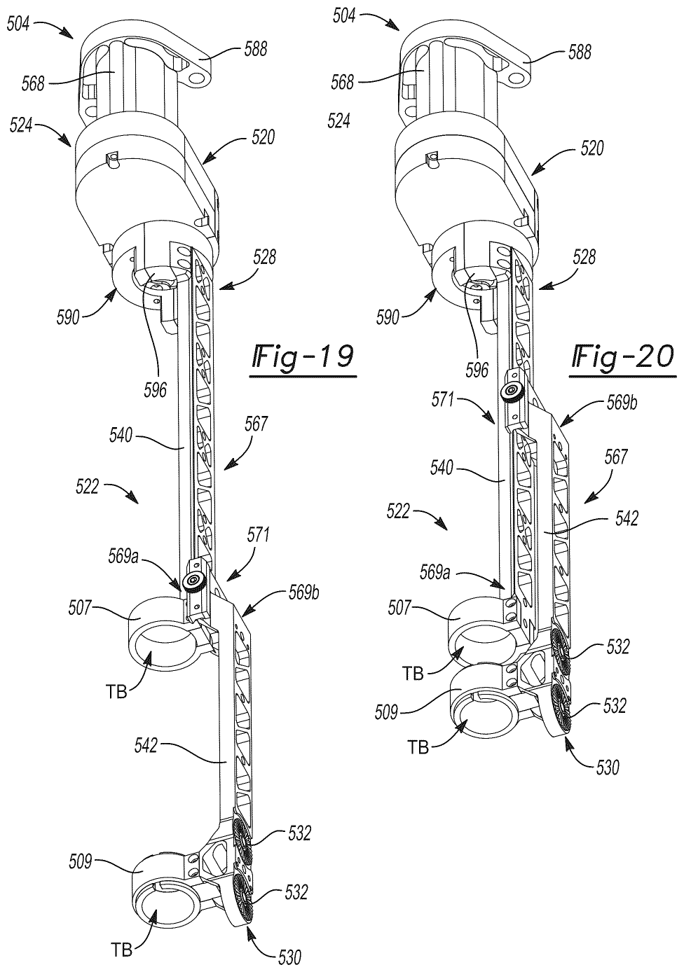

The longitudinal bar 567 of the rotating shaft 522 may be one piece or may have multiple sections or segments to allow the longitudinal bar 567 to telescope and therefore have an adjustable length. In the illustrated embodiment, the longitudinal bar 567 has a generally rectangular cross-sectional shape and is comprised of a upper section 540 that generally runs parallel to the upper portion 112 of the electric trolling motor shaft 106 and a lower section 542 that generally runs parallel to the lower portion 114 of the electric trolling motor shaft 106. The upper section 540 of the longitudinal bar 567 extends between the first shaft end 528 and a first intermediate end 569a and the lower section 542 of the longitudinal bar 567 extends between a second intermediate end 569b and the second shaft end 530. The first and second intermediate ends 569a, 569b of the upper and lower sections 540, 542 of the longitudinal bar 567 are joined by a clamp assembly 571. Although other arrangements are possible, in the illustrated example, there is a beveled edge 573 on each side of the upper section 540 of the longitudinal bar 567. The clamp assembly 571 comprises a fixed jaw 575 that extends from the second intermediate end 569b of the lower section 542 and a movable jaw 577 that opposes the fixed jaw 575 and that is moveably attached to the second intermediate end 569b of the lower section 542 by a bolt 579 and knob 581. The jaws 575, 577 of the clamp assembly 571 have opposing channels 583 that are complementary in shape to and that receive the beveled edges 573 on the upper section 540 of the longitudinal bar 567. A user may rotate/turn the knob 581 to loosen the bolt 579, allowing the lower section 542 of the longitudinal bar 567 to slide longitudinally relative to the upper section 540 of the longitudinal bar 567, which does not slide in the longitudinal direction because the first shaft end 528 of the upper section 540 is coupled to the upper collar 590. As shown in FIGS. 19-20, the upper section 540 of the longitudinal bar 567 is closer to the common axis of rotation 538 than the lower section 542 of the longitudinal bar 567 such that at least a portion of the lower section 542 of the longitudinal bar 567 is configured to slide over at least a portion of the upper section 540 of the longitudinal bar 567 in a partially overlapping arrangement. This enables the user to adjust the length of the longitudinal bar 567 to change the depth of the transducer mounting point 532 and therefore the sonar transducer 134 and/or to accommodate electric trolling motors 100 of different shaft lengths (e.g., 36″, 45″, 52″, 65″, etc.). Once a desired length of the longitudinal bar 567 is set, the user may then rotate/turn the knob 581 to tighten the bolt 579, which clamps the movable jaw 577 against the upper section 540 of the longitudinal bar 567 and prevents the lower section 542 of the longitudinal bar 567 from sliding longitudinally relative to the upper section 540 of the longitudinal bar 567.

Optionally, the rotating shaft 522 may include an intermediate collar 507 that is mounted to the first intermediate end 569a of the upper section 540 of the longitudinal bar 567 and/or a lower collar 509 that is mounted to the lower section 542 of the longitudinal bar 567 at the second shaft end 530 (i.e., adjacent to the transducer mounting point 532). The intermediate and/or lower collars 507, 509 may be made of acetal plastic and may have a split or C-shape so that they can be slid over the electric trolling motor shaft 106 without requiring trolling motor disassembly and the opposing ends of the intermediate and/or lower collars 507, 509 may then be attached to mounting points on the upper and lower sections 540, 542 of the longitudinal bar 567. Thus, the intermediate and/or lower collars 507, 509 extend circumferentially about at least a portion of the electric trolling motor shaft 106 in a clearance fit such that the electric trolling motor shaft 106 can freely turn within the intermediate and/or lower collars 507, 509. In this way, the intermediate and/or lower collars 507, 509 provide additional support and prevent the upper and lower sections 540, 542 of the longitudinal bar 567 from becoming bent or broken by impact or by the sonar transducer 134 bouncing in rough water when the electric trolling motor 100 is stowed.

It should be appreciated that the sonar transducer mount and aiming system 504 described herein can be utilized with a wide variety of different electric trolling motors 100, including electric trolling motors 100 with one long electric trolling motor shaft 106 that rotates and electric trolling motors 100 with a two-piece shaft arrangement that include a larger diameter upper portion 112 of the electric trolling motor shaft 106 that does not rotate and a smaller diameter lower portion 114 of the electric trolling motor shaft 106 that does rotate. When the sonar transducer mount and aiming system 504 is installed on electric trolling motors 100 with a two-piece shaft arrangement, the intermediate collar 507 is positioned such that it extends circumferentially about at least a portion of the upper portion 112 of the electric trolling motor shaft 106 in a clearance fit, while the lower collar 509 is positioned to extend circumferentially about at least a portion of the lower portion 114 of the electric trolling motor shaft 106 in a clearance fit. Optionally, the lower collar 509 may include a shim 509a to account for the smaller diameter of the lower portion 114 of the electric trolling motor shaft 106.

The housing 524 of the rotary actuator assembly 520 is fixedly secured to the upper portion 112 of the electric trolling motor shaft 106. The housing 524 of the rotary actuator assembly 520 includes a pair of opposing jaws 544, 546 that are coupled to one another, by fasteners, for example, and clamp around the upper portion 112 of the electric trolling motor shaft 106 to fixedly secure the housing 524 in place. In particular, the housing 524 is made of three pieces, an upper housing piece 548, a lower housing piece 550, and an end piece 552. In the illustrated example, the end piece 552 includes jaw 544 and the upper housing piece 548 includes jaw 546. Alternatively, or in addition to this clamp structure, the housing 512 of the rotary actuator assembly 520 may be fixedly secured to the pivoting support arm 116 of the electric trolling motor 102 by fasteners 554 and/or a bracket 588.

The rotary actuator assembly 520 includes a drive gear 564 and the rotating coupler 526 includes gear teeth 566 that are arranged in meshing engagement with the drive gear 564 such that rotation of the drive gear 564 drives rotation of the rotating coupler 526 relative to the housing 524. The rotary actuator assembly 520 includes an electric motor 568 with a drive shaft 570 that is coupled to and rotates with the drive gear 564 such that energization of the electric motor 568 drives rotation of the drive gear 564 within the housing 524. The housing 524 of the rotary actuator assembly 520 includes a first cavity 556 that receives the rotating coupler 526, which is coupled to the upper collar 590 using fasteners (e.g., bolts) that extend through a flex disc 591. The housing 524 also includes a second cavity 572 that receives the drive gear 564. The first and second cavities 556, 572 within the housing 524 overlap where the gear teeth 566 on the rotating coupler 526 meshingly engage the drive gear 564.

In the illustrated example, the rotating coupler 526 includes an annular groove 574 and the housing 524 of the rotary actuator assembly 520 includes an inwardly extending flange 576 that is received in the annular groove 574 in the rotating coupler 526 to prohibit axial movement of the rotating coupler 526 relative to the housing 524. The rotating coupler 526 includes a plurality of lobes 594 below the annular groove 574 and a plurality of valleys 595 that are positioned between the lobes 594. The lobes 594 are adjacent to and define part of the annular groove 574 in the rotating coupler 526. The rotating shaft 522 is coupled to the rotating coupler 526 by the upper collar 590 and flex disc 591. The upper collar 590 includes a cup portion 597 that receives the flex disc 591 and the lobes 594 on the rotating coupler 526 and a shoulder portion 596 that bolts to the first shaft end 528 on the upper section 540 of the rotating shaft 522. The upper collar 590 also includes a plurality of pockets 598 that are radially offset from the lobes 594 on the second portion 560 of the rotating coupler 526 and a plurality of buttresses 599 that are positioned between the pockets 598 and are aligned with the lobes 594 on the rotating coupler 526. The flex disc 591 bolts to the rotating coupler 526 using a first group of fasteners that extend up through the flex disc 591 and thread into holes in the lobes 594 on the rotating coupler 526. The flex disc 591 bolts to the upper collar 590 using a second group of fasteners that extend down through the flex disc 591 and thread into holes in the buttresses 599 in the upper collar 590. Once assembled, the upper collar 590 and rotating shaft 522 rotate together with the rotating coupler 526 and the rotating shaft 522 can still flex with the electric trolling motor shaft 106 due to the configuration of the flex disc 591, the lobes 594 and valleys 595 on the rotating coupler 526, and the pockets 598 and buttresses 599 on the upper collar 590, which all cooperate to increase the degree of articulation (range of movement) permitted by the connection between the rotating shaft 522 and the rotating coupler 526.

The rotating coupler 526 has a split arrangement with a first coupler half 584 and a second coupler half 586 that are fastened or otherwise secured to one another to form an annular or cylindrical shape. The upper collar 590 also has a split arrangement with a first collar half 547 and the second collar half 549 that are fastened or otherwise secured to one another. Advantageously, the split/clamshell arrangement of the rotating coupler 526 combined with the clamp arrangement of the housing 524 allows the sonar transducer mount and aiming system 504 to be easily installed over the electric trolling motor shaft 106 without disassembly of the electric trolling motor 102.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. These antecedent recitations should be interpreted to cover any combination in which the inventive novelty exercises its utility. Many modifications and variations of the present invention are possible in light of the above teachings and may be practiced otherwise than as specifically described while within the scope of the appended claims. In addition, the steps of the method set forth herein may be practiced in a different order than that listed herein.

What is claimed is:

1. A sonar transducer mount and aiming system for attachment to an electric trolling motor having an electric trolling motor shaft, comprising:
a rotary actuator assembly including a housing that is configured to be fixedly secured to the electric trolling motor and a rotating coupler that is rotationally driven relative to the housing; and
a rotating shaft extending between a first shaft end that is connected to and rotates with the rotating coupler of the rotary actuator assembly and a second shaft end that includes a sonar transducer mounting point,
wherein the rotating shaft of the sonar transducer mount and aiming system and the electric trolling motor shaft have a common axis of rotation and are configured to rotate independently from one another about the common axis of rotation.

2. The sonar transducer mount and aiming system as set forth in claim 1, wherein the rotating shaft includes a longitudinal bar that is radially offset from, runs parallel to, and is configured to rotate in an orbit about the common axis of rotation of the rotating shaft and the electric trolling motor shaft.

3. The sonar transducer mount and aiming system as set forth in claim 2, wherein the rotating shaft includes an upper collar that rotatably couples the longitudinal bar to the rotating shaft.

4. The sonar transducer mount and aiming system as set forth in claim 3, wherein the longitudinal bar includes an upper section that is coupled to the upper collar and a lower section that includes the sonar transducer mounting point and is configured to be moveable relative to the upper section to give the longitudinal bar an adjustable length.

5. The sonar transducer mount and aiming system as set forth in claim 4, wherein the rotating shaft includes a lower collar that is mounted to the lower section of the longitudinal bar and that is configured to extend circumferentially about at least a portion of the electric trolling motor shaft in a clearance fit.

6. The sonar transducer mount and aiming system as set forth in claim 5, wherein the rotating shaft includes an intermediate collar that is mounted to the longitudinal bar between the upper collar and the lower collar and wherein the intermediate collar is configured to extend circumferentially about at least a portion of the electric trolling motor shaft in a clearance fit.

7. The sonar transducer mount and aiming system as set forth in claim 4, wherein the rotating shaft includes a clamp assembly that is configured to clamp the lower section of the longitudinal bar to the upper section of the longitudinal bar.

8. The sonar transducer mount and aiming system as set forth in claim 3, wherein the longitudinal bar is one-piece and extends longitudinally from the first shaft end that is coupled to the upper collar and the second shaft end that includes the sonar transducer mounting point.

9. The sonar transducer mount and aiming system as set forth in claim 3, wherein the rotating coupler includes a plurality of lobes, wherein the upper collar includes a plurality of buttresses that are aligned with the lobes on the rotating coupler, wherein a flex disc is bolted to the second portion of the rotating coupler by a first group of fasteners that thread into holes in the lobes, and wherein the flex disc is bolted to the upper collar by a second group of fasteners that thread into holes in the buttresses such that the upper collar and the rotating shaft rotate with the rotating coupler while permitting the rotating shaft to flex with the electric trolling motor shaft.

10. The sonar transducer mount and aiming system as set forth in claim 3, wherein the rotating coupler has a split arrangement with a first coupler half and a second coupler half that are fastened or secured to one another to form an annular or cylindrical shape and wherein the upper collar also has a split arrangement with a first collar half and a second collar half that are fastened or secured to one another to form an annular or cylindrical shape.

11. The sonar transducer mount and aiming system as set forth in claim 1, wherein the rotating shaft has a split arrangement with a first shaft half and a second shaft half that are fastened or secured to one another to collectively define a tubular shape and a through bore that is configured to receive at least a portion of the electric trolling motor shaft in a co-axial arrangement and a clearance fit.

12. The sonar transducer mount and aiming system as set forth in claim 1, wherein the rotating shaft includes a one-piece tubular segment with a through bore that is configured to receive at least a portion of the electric trolling motor shaft in a co-axial arrangement and a clearance fit.

13. A system, comprising:
an electric trolling motor including an electric trolling motor shaft and a lower unit connected to the electric trolling motor shaft; and
a sonar transducer mount and aiming system including a rotary actuator assembly and a rotating shaft, the rotary actuator assembly having a housing that is fixedly secured to the electric trolling motor and a rotating coupler that is rotationally driven relative to the housing,
wherein the rotating shaft extends between a first shaft end that is connected to and rotates with the rotating coupler of the rotary actuator assembly and a second shaft end that includes a sonar transducer mounting point,
wherein the rotating shaft of the sonar transducer mount and aiming system and at least a portion of the electric trolling motor shaft independently rotate about a common axis that forms a centerline of the electric trolling motor shaft.

14. The system as set forth in claim 13, wherein the electric trolling motor shaft includes an upper portion that is rotatably fixed to a pivoting support arm of the electric trolling motor and a lower portion that is connected to the lower unit of the electric trolling motor and that rotates relative to the upper portion of the electric trolling motor shaft and wherein the housing of the rotary actuator assembly is fixedly secured to at least one of the upper portion of the electric trolling motor shaft and the pivoting support arm of the electric trolling motor.

15. The system as set forth in claim 13, wherein the electric trolling motor includes a pivoting support arm that holds at least a portion of the electric trolling motor shaft and wherein the housing of the rotary actuator assembly is fixedly secured to the pivoting support arm of the electric trolling motor.

16. The system as set forth in claim 13, wherein the rotating shaft includes a longitudinal bar that is radially offset from and runs parallel to the electric trolling motor shaft and that is configured to rotate in an orbit about the common axis of rotation of the rotating shaft and the electric trolling motor shaft.

17. A sonar transducer mount and aiming system for attachment to an electric trolling motor of a boat, comprising:
a rotary actuator assembly including a housing that is configured to be fixedly secured to the electric trolling motor, a rotating coupler that is rotationally driven relative to the housing by an electric motor that is coupled to the rotating coupler through a gear set;
a rotating shaft extending between a first shaft end that is connected to and rotates with the rotating coupler of the rotary actuator assembly and a second shaft end that includes a sonar transducer mounting point, the rotating shaft of the sonar transducer mount and aiming system is configured to rotate independently of the electric trolling motor shaft; and
a control pedal electronically connected to the electric motor of the rotary actuator assembly, the control pedal configured to adjust a rotational position of the rotating shaft and therefore a heading associated with the sonar transducer mounting point.

18. The sonar transducer mount and aiming system as set forth in claim 17, further comprising:
an array of indicator lights mounted along a lighted perimeter of the boat that provide a first illuminated heading that corresponds with the heading associated with the sonar transducer mounting point.

19. The sonar transducer mount and aiming system as set forth in claim 18, wherein the lighted perimeter about which the array of indicator lights are arranged extends around at least a portion of a casting deck or gunnel of the boat.

20. The sonar transducer mount and aiming system as set forth in claim 18, wherein the array of indicator lights provide a second illuminated heading that corresponds with a user selected heading and first and second illuminated pan limits that are user selectable and that define two radial limits for an automated sweep mode, and wherein a control circuit is programmed with a manual operating mode where the control circuit energizes the electric motor to rotate the rotating shaft in a clockwise rotational direction or a counterclockwise rotational direction until the first illuminated heading matches the second illuminated heading and wherein the control circuit is programmed with an automated sweep operating mode where the control circuit energizes the electric motor to rotate the rotating shaft in a clockwise rotational direction and then a counterclockwise rotational direction so that the first illuminated heading sweeps back and forth between the first and second illuminated pan limits.
